(19) United States
(12) Patent Application Publication
(10) Pub. No.: US 2026/0141476 A1
(43) Pub. Date: May 21, 2026

(54) SVM DEVICE FOR REENACTING PAST DRIVING SITUATIONS

(71) Applicant: Kang San CHOI, Seoul (KR)

(72) Inventor: Kang San CHOI, Seoul (KR)

(21) Appl. No.: 19/449,017

(22) Filed: Jan. 14, 2026

Related U.S. Application Data
(63) Continuation-in-part of application No. 18/519,777, filed on Nov. 27, 2023, now abandoned.

(30) Foreign Application Priority Data
Apr. 15, 2023 (KR) 10-2023-0049701

(51) Int. Cl. G06T 3/16; G06T 19/00; G07C 5/04; G07C 5/06; H04N 7/18

(52) U.S. Cl. CPC G06T 3/16; G06T 19/00; G07C 5/04; G07C 5/06; H04N 7/181; G06T 2200/24

(57) ABSTRACT

A technology for recording and playing SVM video for a vehicle is disclosed. The device records camera videos from multi-channel cameras and, upon user request, decodes these files to provide an SVM environment identical to actual driving. By converting recorded streams into a format compatible with the live SVM synthesis pipeline, the system allows for detailed reenactment of past situations, including 3D viewpoint adjustments, assisting users in minutely understanding past events.

### CROSS-REFERENCE TO RELATED APPLICATIONS

This application is a continuation-in-part application of a U.S. patent application Ser. No. 18/519,777, filed on Nov. 27, 2023, the entire contents of which are incorporated herein by reference.

### BACKGROUND OF THE INVENTION

### Field of the Invention

The present disclosure relates generally to technology for recording and playing surround view monitoring (SVM) video for a vehicle. More specifically, it relates to an SVM recording and playback technology that reenacts past driving situations by utilizing recorded multi-channel camera files to provide a monitoring environment identical to actual driving.

### Description of the Related Art

Surround view monitoring (SVM) system for vehicle has been widely spread. The SVM, which is also called around view monitoring (AVM), is a technology of providing a top view or a bird's view by installing cameras on the front, rear, left, and right of a vehicle, capturing the front, rear, left, and right areas of the vehicle, and combining the videos obtained through the cameras. Drivers can exactly know the situation around a vehicle, so driving or parking becomes convenient.

FIG. 1 is a conceptual view of vehicle SVM technology. Cameras 11 to 14 are mounted on the front and rear and both side mirrors of a vehicle and camera videos 15 to 18 are obtained from these multi-channel cameras 11 to 14. The camera videos 15 to 18 are made into flat images by applying image enhancement and distortion correction (calibration) and then stitching (image registration and combination) is performed, whereby a surround view video 19 is obtained. The surround view video 19 is provided to the driver through a monitor in the vehicle.

FIG. 2 shows exemplary 2D and 3D SVM images. FIG. 2(a) is a 2D SVM video in which the left one is a rear camera video and the right one is a bird's eye view (top view) video. In the 2D SVM video, two adjacent camera videos are shown translucently overlapped in the boundary combination regions between the videos by the front and rear camera videos 15 and 16 and both side camera videos 17 and 18. FIG. 2(b) is a 3D SVM video, in which the 3D SVM video provides combination videos in a 3D viewpoint, thereby enabling the driver to know the situation around the vehicle. When a user touches the monitor videos of FIG. 2(a) and (b), it is possible to see the situation around the vehicle while changing the viewpoint.

SVM devices may provide a function of recording camera videos 15 to 18 generated by the multi-channel cameras 11 to 14 and playing the videos later. FIG. 3 shows a conventional recorded video playback screen. In general, videos distorted by wide angle cameras are played as it is, as shown in FIG. 3. Further, an SVM device may provide a function of recording a surround view video 19 and playing the surround view video 19 later. A surround view video 19 provided to a user through a monitor in a vehicle is recorded as it is and played.

The SVM technology is applied for preventing car accidents during driving. Further, the SVM technology is applied for securing evidences when an accident occurs. It is required to expand the SVM technology.

### SUMMARY OF THE INVENTION

An objective of the present disclosure is to provide a technology for reenacting past driving situations. By recording multi-channel camera videos and later re-inserting them into the SVM synthesis pipeline, the device allows a user to understand a specific past time point with the same level of detail and control as real-time monitoring.

According to an aspect of the present disclosure, the SVM device includes: a processor; and a memory storing instructions that, when executed by the processor, cause the processor to: (a) receive a plurality of camera videos from multi-channel cameras installed on a vehicle; (b) generate an SVM video by executing an image stitching algorithm comprising a sequence of operations to combine the received camera videos; (c) output the SVM video for display; (d) encode the received camera videos to generate multi-channel camera videos and store the multi-channel camera videos in a storage as a series of video files in chronological order; (e) decode, in response to a request to reenact past driving situations, at least one of the video files to generate multi-channel video streams; and (f) convert the multi-channel video streams into decoded camera videos and direct the decoded camera videos to an input of the image stitching algorithm via the input buffer, wherein the decoded camera videos are provided in a same data format as the camera videos received in step (a) to cause the image stitching algorithm to generate a reenacted SVM video.

### BRIEF DESCRIPTION OF THE DRAWINGS

FIG. 1 is a conceptual view of vehicle SVM technology.

FIG. 2 shows exemplary 2D and 3D SVM images.

FIG. 3 shows a conventional recorded video playback screen.

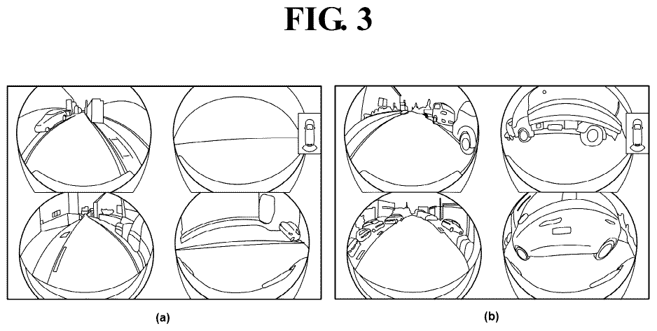

FIG. 4 is a block diagram of an SVM device according to a first embodiment.

FIG. 5 is a block diagram of an SVM device according to a second embodiment.

FIG. 6 is an exemplary view of playback images of 2D SVM recorded videos by the present disclosure.

FIG. 7 is an exemplary view of playback images of 3D SVM recorded videos by the present disclosure.

FIG. 8 is an exemplary view of playback images of 3D SVM recorded videos by the present disclosure.

FIG. 9 is a flowchart of an image stitching algorithm.

FIG. 10 is a flowchart showing a data redirection during reenactment.

FIG. 11 is a hardware block diagram of an SVM device.

FIG. 12 is a block diagram illustrating the data processing flow and buffer structure.

FIG. 13 is a state diagram of the reenaction controller.

### DESCRIPTION OF THE PREFERRED EMBODIMENTS

Hereinafter, embodiments of the present invention will be described in detail with reference to the drawings. The present invention is not limited to these embodiments, and various modifications can be made thereto and can have various forms.

The terms “unit,” “receiver,” “encoder,” “decoder,” and “converter” as used herein do not merely represent functional labels. Instead, they refer to a hardware circuit that performs a specific function, a processor configured to execute specific program instructions to perform said function, or a combination thereof. Each of these components is a specific hardware configuration or a software module of a computing device specially programmed to execute the algorithms presented in the flowcharts and descriptions of this disclosure. Therefore, these terms are not intended to be interpreted as a “means-plus-function” limitation under 35 U.S.C. 112(f).

The processor of the SVM device 100 operates as a special-purpose computing device physically configured or logically programmed to perform the step-by-step processes disclosed herein by loading executable instructions from memory. This configuration ensures that a general-purpose processor is transformed into a specific hardware implementation designed to reenact past driving situations by utilizing recorded multi-channel camera files to provide a monitoring environment identical to actual driving.

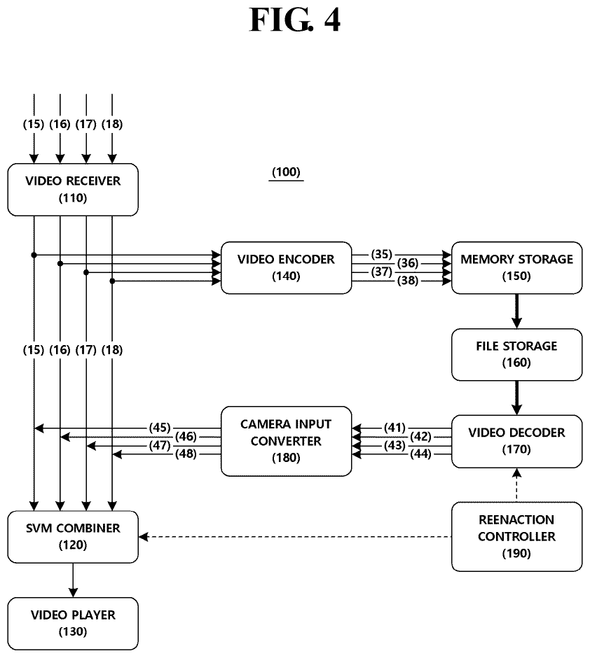

FIG. 4 is a block diagram of an SVM device according to a first embodiment of the present disclosure.

An SVM device according to the present disclosure provides a surround view monitoring (SVM) function using multi-channel cameras 11 to 14 which are installed on a vehicle. The SVM device according to the present is characterized in that it records a plurality of camera videos 15 to 18 which are obtained from the multi-channel cameras 11˜14 as video files in a storage space, and then, by using the recorded video files, provides an SVM environment which is the same as actual driving.

Accordingly, the situation around the vehicle at the moment of SVM recording is reenacted and played the same as the actual driving through SVM, thereby assisting a user to be able to minutely understand the situation at a specific time point in the past. As an embodiment, a user can minutely see the surrounding of a vehicle through an SVM image. Further, a user can closely see the surrounding of a vehicle at various angles by turning a viewpoint 360 degrees through user's touch operation.

Referring to FIG. 4, the SVM device for reenacting past driving situations according to the present disclosure include a video receiver 110, an SVM combiner 120, a video player 130, a video encoder 140, a memory storage 150, a file storage 160, a video decoder 170, a camera input converter 180, and a reenaction controller 190. These components (110 to 190) may be implemented as hardware circuitry or as software algorithms executed by a processor through instructions stored in a memory.

The video receiver 110 is a component that receives a plurality of camera videos 15 to 18 obtained from multi-channel cameras 11 to 14 installed on a vehicle for SVM. The video receiver 110 transmits the camera videos 15 to 18 in the form of a plurality of videos or in the form of one combined video to the video encoder 140.

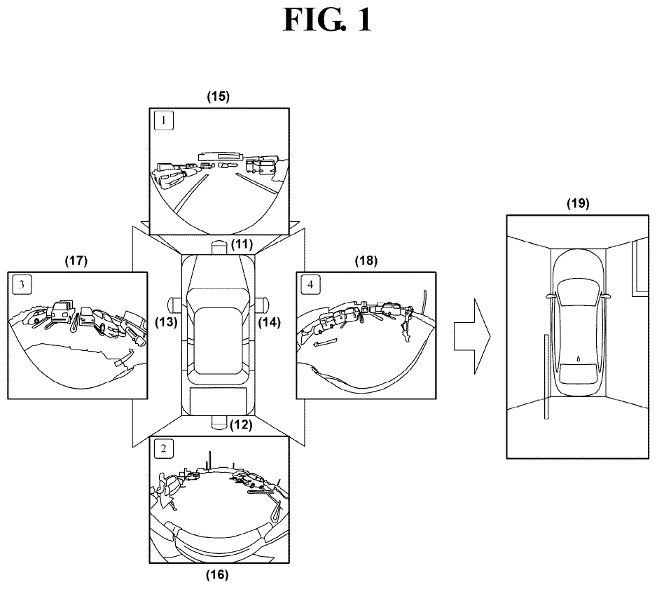

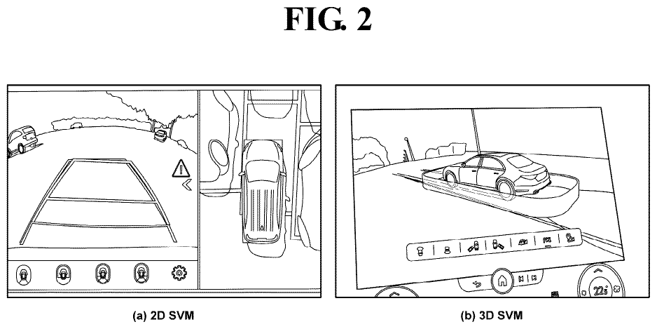

The SVM combiner 120 is a component that is provided with the plurality of camera videos 15 to 18 from the video receiver 110 and generates an SVM video by combining the videos. For example, as described above with reference to FIG. 1 and FIG. 2, image enhancement, distortion correction, and stitching are performed on the plurality of camera videos 15 to 18, whereby 2D SVM videos or 3D SVM videos are generated. To this end, the SVM combiner 120 stores a setting value (parameter value) for SVM registration. In this case, as described above with reference to FIG. 2, the SVM combiner 120 can configure an SVM image while changing the viewpoint in response to operation by a user.

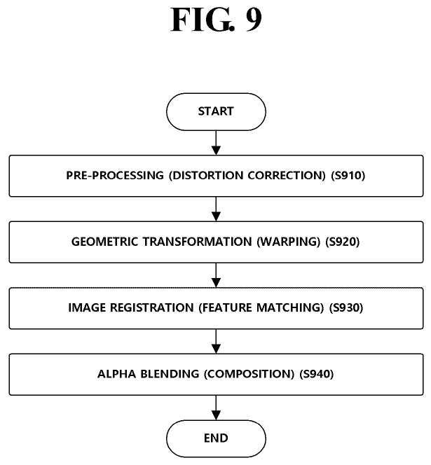

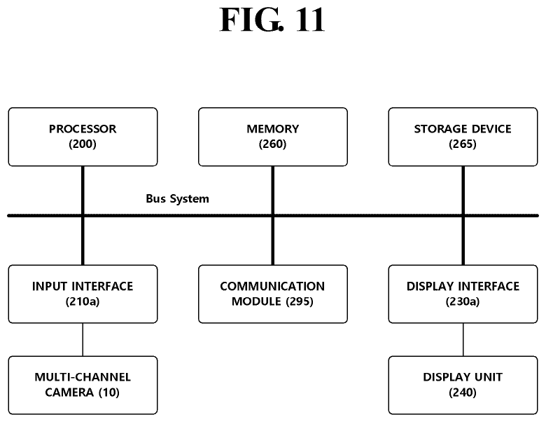

The SVM combiner 120 may be implemented by the processor 200 shown in FIG. 11 executing software instructions stored in the memory 260 to perform an image stitching algorithm. An embodiment of the image stitching algorithm performed by the processor 200 will be described later with reference to FIG. 9. The image stitching algorithm may be preferably performed by an encoder and a decoder of a Video Processor Unit (VPU) embedded in the processor 200.

The video player 130 is a component that plays and displays an SVM video generated by the SVM combiner 120. In one embodiment, the video player 130 outputs a series of image frames of the SVM video to a display buffer so that the SVM video is displayed on a screen.

The video encoder 140 is a component that generates multi-channel camera videos 35 to 38 by encoding the camera videos 15 to 18 received by the video receiver 110. The multi-channel camera videos 35 to 38 may be in the form of a plurality of videos or the form of one combined video. In one embodiment, the video encoder 140 synthesizes a plurality of camera videos 15 to 18 into a single image, and transmits the single image to a hardware encoder of a Video Processor Unit (VPU) embedded in the processor 200 to encode the single image into an H.264 or H.265 format.

The memory storage 150 is a component that temporarily stores the multi-channel camera videos 35 to 38 generated by the video encoder 140. The memory storage 150 can function as a memory buffer for solving a data processing timing difference between the video encoder 140 and the file storage 160.

The file storage 160 is a component that reads out the multi-channel camera videos 35 to 38 temporarily stored in the memory storage 150 and stores them as a series of video files in chronological order (e.g., one video file per 30 seconds) in a storage device, e.g. SD card, eMMC, USB memory stick in an H.264 or H.265 format.

The video decoder 170 is a component that generates multi-channel video streams 41 to 44 by decoding some of the series of video files stored in the file storage 160. In one embodiment, the video decoder 170 reads video files from the file storage unit 160 and decodes the video files using a hardware decoder of a video processor unit (VPU) embedded in the processor 200. The operation of the video decoder 170 decoding the video files stored in the file storage 160 is an operation that is performed when the SVM device 100 intends to reenact past driving situations. In this case, which video file of the series of video files stored in the file storage 160 the video decoder 170 selects as an object of decoding corresponds to the reenaction time point that a user want to see.

The reenaction controller 190 is a component that controls selection of video files to be decoded by the video decoder 170 in response to a user's touch operation (e.g., rewinding, stopping, fast forwarding, clicking a specific point, etc.) by a user adjusting a drive situation reenaction time point. In addition, the reenaction controller 190 controls the SVM combiner 120 in response to a user's touch operation (e.g., changing a viewpoint, zooming in, zooming out, etc.) performed on a driving situation reenacting screen.

The camera input converter 180 is a component that converts the multi-channel streams 41 to 44 generated by the video decoder 170 into a plurality of camera videos 45 to 48 for SVM combination and then inserts the videos into a transmission channel of a plurality of camera videos 15 to 18 that goes from the video receiver 110 to the SVM combiner 120. In one embodiment, the camera input converter 180 splits the video decoded by the camera input converter 180 170 to configure a plurality of camera videos 45 to 48, and inserts the camera videos 45 to 48 into transmission channels of a plurality of camera videos 15 to 18 directed from the video receiver 110 to the SVM combiner 120. Accordingly, the SVM combiner 120 receives the plurality of camera videos 45 to 48 from the camera input converter 180 in the same format as when the camera videos 15 to 18 are input from the video receiver 110. The SVM combiner 120 generates an SVM video by combining the camera videos 45 to 48 in a similar manner of generating an SVM video by combining the camera videos 15 to 18.

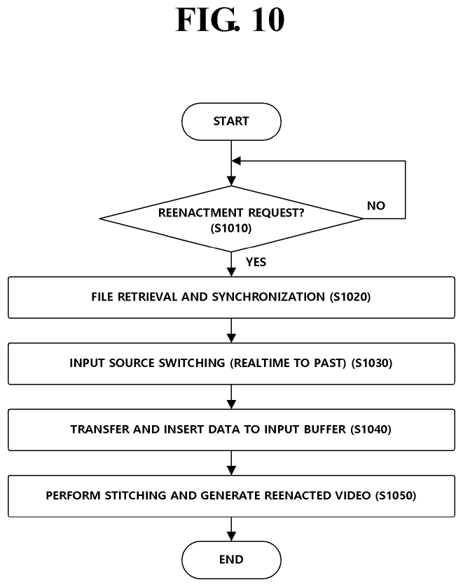

The camera input converter 180 and the reenaction controller 190 may be implemented by the processor 200 shown in FIG. 11 executing software instructions stored in the memory 260 to perform data processing logic for reenacting past driving situations. An embodiment of the data processing logic performed by the processor 200 for reenacting past driving situations will be described later with reference to FIGS. 10 to 13. In an embodiment, in order to provide a structure for the camera input converter 180, the processor 200 may execute an arbitration logic that switches a direct memory access (DMA) channel between the first input buffer (181) and the second input buffer (182).

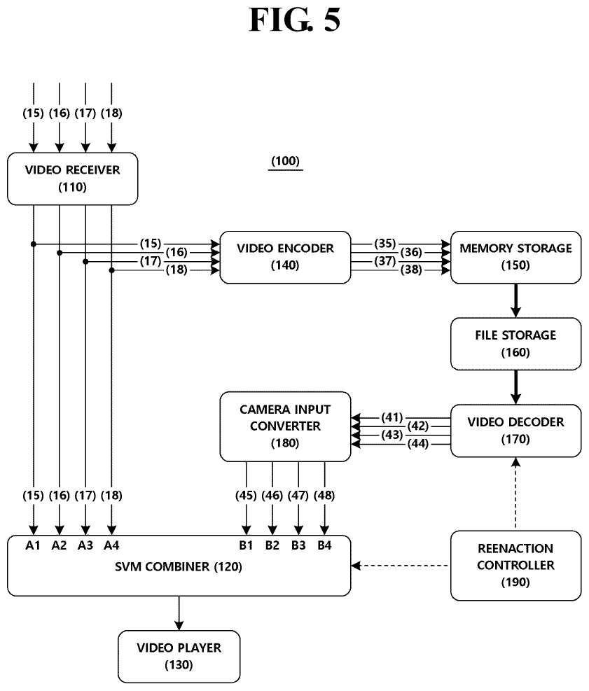

FIG. 5 is a block diagram of an SVM device according to a second embodiment of the present disclosure.

Comparing with the first embodiment of FIG. 4, the second embodiment of FIG. 5 has a difference in that the SVM combiner 120 has two input channels A1 to A4 and B1 to B4. The first input channel A1 to A4 provides a path for receiving a plurality of camera videos 15 to 18 from the video receiver 110. This is intended for processing real-time videos which are acquired during actual driving of the vehicle. The second input channel B1 to B4 provides a path for receiving a plurality of camera videos 45 to 48 from the camera input converter 180.

The SVM combiner 120 selects any one of the two input channels A1 to A4 and B1 to B4 depending on whether a user wants a current SVM video or an SVM video for reenacting past driving situations. The SVM combiner 120 generates an SVM video by combining a plurality of camera videos 15 to 18 or 45 to 48 that is input through the selected input channel. Through this, the SVM combiner 120 generates a surround view video corresponding to the user's intent and displays the generated video on a screen. The user's intent includes a selective request to either monitor a real-time surround view video during current driving or to reenact a past driving situation at a specific past time point by retrieving stored video files.

FIG. 9 is a flowchart of an image stitching algorithm.

The processor 200 performs an image stitching algorithm to generate an SVM image from a plurality of camera videos (15 to 18 or 45 to 48). The image stitching algorithm performed by the processor 200 includes the following detailed operation steps.

The processor 200 performs a pre-processing step of correcting distortion caused by wide-angle lens characteristics for each received multi-channel camera video (S910). Subsequently, the processor 200 performs geometric transformation (warping) of each distortion-corrected video into a top-view plane image using a predefined mapping table (S920). Next, the processor 200 performs image registration by matching feature points in overlap regions between the transformed plane images to align the coordinate systems of each video (S930). Finally, the processor 200 performs alpha-blending to combine the images while adjusting transparency based on a set alpha value to minimize visual discontinuities at the boundaries between the aligned images (S940), thereby generating a final SVM video.

FIG. 10 is a flowchart showing data redirection during reenactment.

In response to a user operation requesting reenaction of a past driving situation, the processor 200 performs data processing logic for reenacting the past driving situation using a plurality of camera videos 45 to 48. The data processing logic performed by the processor 200 for reenacting the past driving situation includes the following detailed operational steps.

The processor 200 monitors whether a drive situation reenactment request signal for a specific time point is received from a user (S1010). If a reenactment request is received (‘Yes’ in S1010), the processor 200 calls a video file corresponding to the timestamp from the file storage 160 and performs synchronization between multi-channels (S1020). Thereafter, the processor 200 switches the input of the image stitching algorithm of the SVM combiner 120 from the real-time camera video path to the decoded video data path (S1030). Next, the processor 200 transfers (inserts) the decoded and synchronized multi-channel camera videos to the input buffer of the image stitching algorithm (S1040). Finally, the SVM combiner 120 generates a reenacted SVM video by performing the stitching algorithm of FIG. 9 using the inserted past videos (S1050).

FIG. 11 is a hardware block diagram of the SVM device.

Referring to FIG. 11, the SVM device may include a processor 200, a memory 260, a storage device 265, an input interface 210a, a display interface 230a, and a communication module 295 connected via a bus system. The processor 200 may be implemented as a Central Processing Unit (CPU), a Graphics Processing Unit (GPU), an Application Processor (AP), or a combination thereof, and executes software instructions stored in the memory 260 to control the image stitching and data redirection algorithms shown in FIGS. 9 and 10. The memory 260 includes volatile memory (e.g., DRAM, SRAM) and non-volatile memory (e.g., Flash Memory), and serves as a buffer for temporarily storing instructions and real-time/decoded video data required for the processor's operation. The storage device 265 is composed of an HDD, SSD, SD card, etc., and stores encoded camera video files for a long time. The input interface 210a is a hardware circuit that receives and buffers video data from the multi-channel camera 10, and the display interface 230a outputs the generated SVM video to the display unit 240.

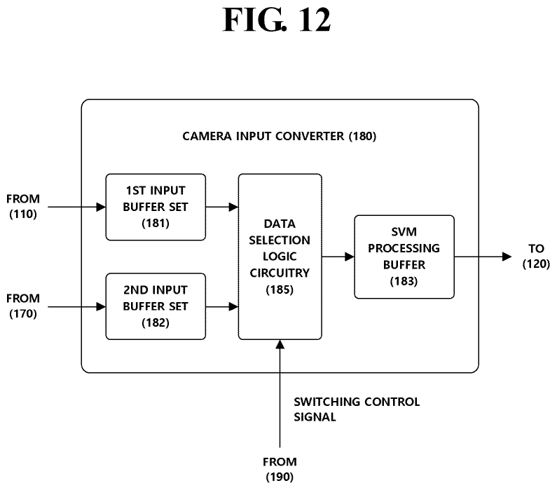

FIG. 12 is a block diagram illustrating the data processing flow and buffer structure of the camera input converter 180 according to an embodiment of the present disclosure.

A detailed data processing structure and operation of the camera input converter 180 will be described with reference to FIG. 12. In this embodiment, the camera input converter 180 may include physical or logical data selection logic circuitry 185 and a plurality of buffer memories.

Specifically, the camera input converter 180 includes a first input buffer set 181 for temporarily storing real-time unit images received from the video receiver 110, and a second input buffer set 182 for temporarily storing restored past images received from the video decoder 170. Each buffer set may include individual First-In-First-Out (FIFO) memory blocks corresponding to a plurality of camera channels (e.g., four channels: front, rear, left, and right).

The data selection logic circuitry 185 operates in response to a switching control signal applied from the reenaction controller 190. The data selection logic circuitry 185 arbitrates access to the SVM processing buffer 183 by selectively routing the data path from either the first input buffer set 181 or the second input buffer set 182 based on the switching control signal. In a normal driving mode, the data selection logic circuitry 185 selects outputs of the first input buffer set 181 and forms a path to transfer them to an SVM processing buffer 183. Conversely, when a switching control signal instructing entry into a past driving situation reenaction mode is received, the data selection logic circuitry 185 physically or logically changes the data path to select outputs of the second input buffer set 182 and transfer them to the SVM processing buffer 183.

The SVM processing buffer 183 temporarily stores image data of the selected source, and the SVM combiner 120 accesses this SVM processing buffer 183 to acquire images. Through this buffering and selection structure, the SVM combiner 120 can process data using the same interface regardless of whether the input source is a real-time image or a past image. Such a configuration of the camera input converter 180 may be implemented using a memory controller within the processor 200 of FIG. 11 or separate hardware multiplexer (MUX) circuitry.

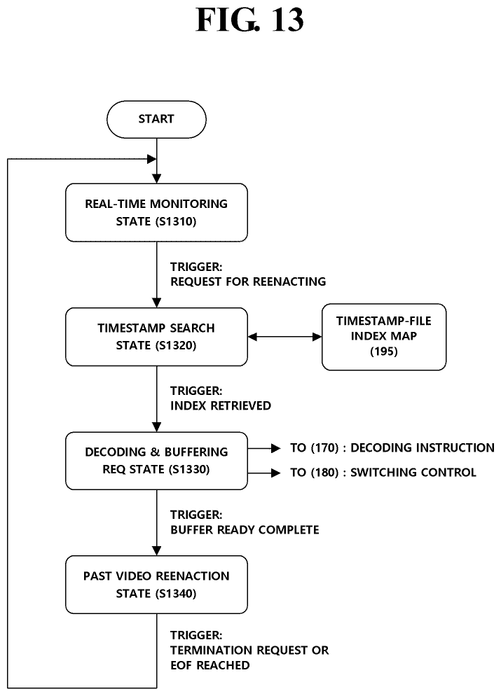

FIG. 13 is a state diagram of the reenaction controller 190 according to an embodiment of the present disclosure.

State transitions and a data retrieval process of control logic performed by the reenaction controller 190 will be described with reference to FIG. 13. The reenaction controller 190 is implemented as a hardware-based or software-defined state machine executed by the processor 200 that manages transitions between operational states based on specific input triggers.

In an initial state, a ‘real-time monitoring state (S1310)’, the reenaction controller 190 monitors whether there is a request for reenacting a past situation from the user input. When a reenaction request trigger occurs, it transitions to a ‘timestamp search state (S1320)’. In this state, the reenaction controller 190 uses a timestamp of a requested time point as a key to query a timestamp-file index map 195 stored in the memory 260 or the file storage 160. This index map 195 is a data structure mapping physical addresses or filenames where image data of specific time intervals are stored.

Once the corresponding index is retrieved, it transitions to a ‘decoding and buffering request state (S1330)’. Here, based on the retrieved index information, it instructs the video decoder 170 to decode a specific file and simultaneously transmits a switching control signal to the camera input converter 180 to prepare for an input path change.

When a signal indicating that the second input buffer set (182, refer to FIG. 12) is sufficiently filled with decoded data (buffer ready complete) is received, it transitions to a ‘past video reenaction state (S1340)’ to start full-scale playback. In this state, playback control according to additional user operations (pause, seek, etc.) is performed. When there is a termination request from the user or the end of file (EOF) of the playback file is reached, it returns to the initial ‘real-time monitoring state (S1310)’ and instructs the camera input converter 180 to return to the original path. Stable situation reenaction functions are performed through this specific state transition logic.

The present disclosure can achieve the following advantages through the technical configuration described above.

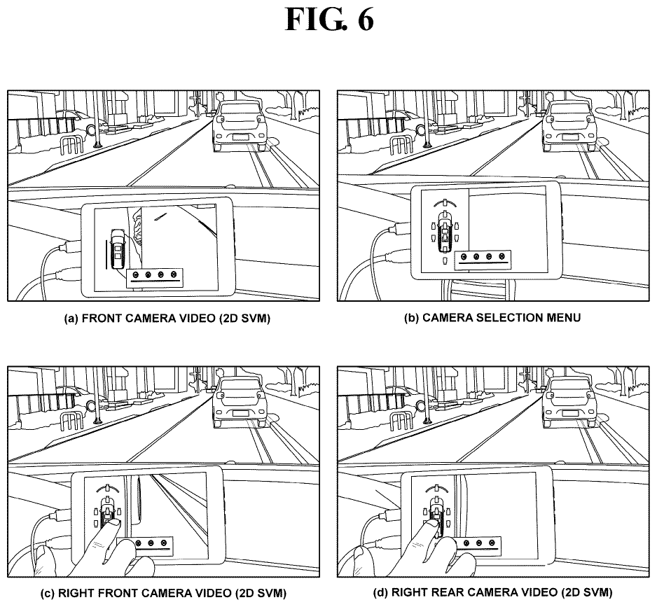

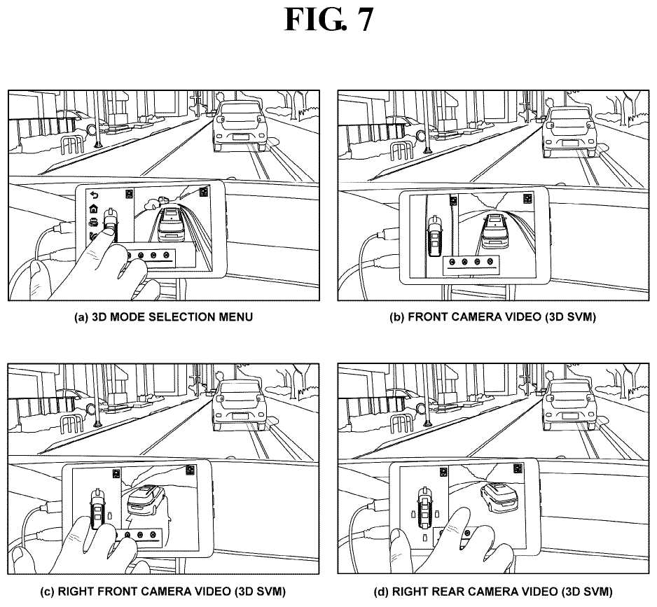

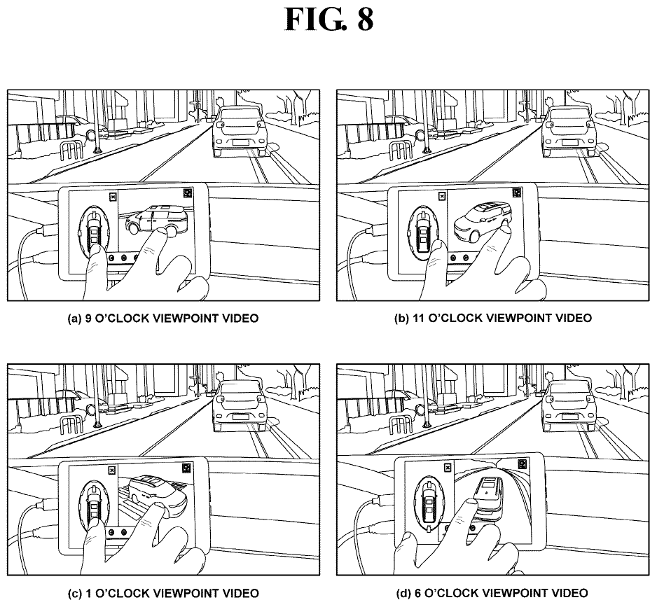

First, using an SVM algorithm, it is possible to reenact the surrounding video of past driving situations recorded in a storage into a top view like seeing from the sky, a 3D view like actually seeing the surrounding of a vehicle, and camera views divided into front/rear/left/right. FIGS. 6 to 8 exemplify playback images of SVM recorded videos of various past driving situations that a user can see by the present disclosure. It is possible to know that it is a reenaction video of past driving situations in that the SVM videos displayed on a monitor in a vehicle are totally different from the current situation seen through the windshield of the vehicle.

Second, a user can reenact and play a surrounding situation around blind spots and at time points at which SVM videos were recorded by distorting and converting videos in several various view modes that make it intuitive and easy to distinguish the contents of videos.

Third, it is possible to play the situation at the moment of recording a video as a combined 3D video at various angles and in a top view state by variously changing views and finely adjusting an angle in a 3D view with the video stopped during playing.

Fourth, it is possible to store and play even a predetermined elapsed time (30 seconds) into a 3D view even after the moment that a user wants to store during driving is past.

Fifth, it is possible to freely correct and combine videos so that the videos are seen without distortion even through a wide angle camera for SVM.

According to the present disclosure, there is an advantage that a user (e.g., a driver) can minutely understand the situation around a vehicle at the moment of an accident because the situation around a vehicle at the moment accident is reenacted in SVM environment.

While the present invention has been described with respect to the specific embodiments, it will be apparent to those skilled in the art that various changes and modifications may be made without departing from the spirit and scope of the invention as defined in the following claims.

What is claimed is:

1. An SVM (Surround View Monitoring) device for reenacting past driving situations, comprising:
a processor; and
a memory storing instructions that, when executed by the processor, cause the processor to:
(a) receive a plurality of camera videos from multi-channel cameras installed on a vehicle;
(b) generate an SVM video by executing an image stitching algorithm comprising a sequence of operations to combine the received camera videos;
(c) output the SVM video for display;
(d) encode the received camera videos to generate multi-channel camera videos and store the multi-channel camera videos in a storage as a series of video files in chronological order;
(e) decode, in response to a request to reenact past driving situations, at least one of the video files to generate multi-channel video streams; and
(f) convert the multi-channel video streams into decoded camera videos and direct the decoded camera videos to an input of the image stitching algorithm via the input buffer, wherein the decoded camera videos are provided in a same data format as the camera videos received in step (a) to cause the image stitching algorithm to generate a reenacted SVM video.

2. The device of claim 1, wherein the instructions further cause the processor to:
(g) receive a user input for adjusting a reenaction time point of the past driving situations; and
(h) select the video file to be decoded in step (e) from the stored series of video files based on the received user input.

3. The device of claim 2, wherein the instructions further cause the processor to:
(i) receive a user input for changing a viewpoint while the reenacted SVM video is being played; and
(j) generate a 3D rotated reenactment video by changing a virtual camera viewpoint angle during the image combination of the multi-channel video streams in response to the received touch input.

4. An SVM (Surround View Monitoring) device for reenacting past driving situations, comprising:
a processor; and
a memory storing instructions that, when executed by the processor, cause the processor to:
(a) receive a plurality of camera videos from multi-channel cameras installed on a vehicle via a video input interface;
(b) encode the received camera videos to generate multi-channel camera videos and store the multi-channel camera videos in a storage as a series of video files;
(c) decode, in response to a request to reenact past driving situations, at least one of the video files to generate multi-channel video streams;
(d) convert the multi-channel video streams into decoded camera videos for SVM combination;
(e) switch a data path to select, in response to a user operation, one of a first input channel configured to receive the camera videos from the video input interface and a second input channel configured to receive the decoded camera videos from the conversion;
(f) generate an SVM video by performing image combination on the camera videos provided through the selected input channel; and
(g) output the generated SVM video for display.

5. The device of claim 4, wherein the instructions further cause the processor to:
(h) receive a user input for adjusting a reenaction time point of the past driving situations; and
(i) select the video file to be decoded in step (c) from the stored series of video files based on the received user input.

6. The device of claim 5, wherein the instructions further cause the processor to:
(j) receive a user input for changing a viewpoint while the reenacted SVM video is being played; and
(k) generate a 3D rotated reenactment video by changing a virtual camera viewpoint angle during the image combination of the multi-channel video streams in response to the received touch input.
